(19) United States
(12) Patent Application Publication
(10) Pub. No.: US 2006/0161623 A1
(43) Pub. Date: Jul. 20, 2006

(54) Methods and apparatuses for selectively sharing a portion of a display for application based screen sampling

(76) Inventors: Elaine Montgomery, Aberdeen (GB); Edward Wong, Fremont, CA (US); Eric Yuan, San Jose, CA (US); Jiannong Gu, Santa Clara, CA (US); Sam Sheng, Fremont, CA (US); David Knight, Belmont, CA (US); Songxiang Wei, San Jose, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/323,192

(22) Filed: Dec. 29, 2005

Related U.S. Application Data
(63) Continuation-in-part of application No. 09/835,079, filed on Apr. 13, 2001.

(51) Int. Cl. G06F 15/16; G06F 15/167

(52) U.S. Cl. 709/204; 709/213

(57) ABSTRACT

In one embodiment, the methods and apparatuses include: sharing desktop content with an attendee device wherein the desktop content corresponds with a presenter device and wherein the desktop content includes a hidden window; preventing the attendee device from viewing the hidden window; displaying the desktop content including the hidden window on the presenter device; and displaying the desktop content excluding the hidden window on the attendee device.

### RELATED APPLICATION

The present invention is a continuation-in-part of prior U.S. patent application Ser. No. 09/835,079, filed on Apr. 13, 2001 entitled “APPLICATION BASED SCREEN SAMPLING,” by Songxiang Wei.

### FIELD OF THE INVENTION

The present invention relates to data conferencing systems, and more particularly, to the sharing of applications during a data conference.

### BACKGROUND

Data conferencing systems allow computer users at different locations to communicate via a computer network and share applications stored and/or executed on one of the users computers. Each user's computer includes a data conferencing software program that enables the users to share applications. Users that share applications during a data conference are referred to herein as presenters. Users that receive the shared applications during a data conference are referred to herein as viewers.

A conventional technique for sharing applications during a data conference is to share a predefined area of the presenter's computer screen with a viewer. Using this technique, the presenter's computer captures an image within a predefined portion of the presenter's computer screen (e.g., the entire computer screen or a rectangular portion of the computer screen). The captured image within the predefined portion of the presenter's computer screen is then transmitted to the viewer's computer. The viewer's computer then displays the transmitted image on the viewer's computer screen. Thus, replicas of any windows that are displayed within the predefined portion of the presenter's computer screen are displayed on the viewer's computer screen.

A disadvantage of this application sharing technique is that all application windows displayed within the predefined portion of the presenter's computer screen (e.g., the entire computer screen or a rectangular portion of the computer screen) are captured and transmitted to the viewer. There is no way for the presenter to selectively share application windows with the viewer. Thus, the presenter must be careful not to have application windows placed within the predefined portion of the presenter's computer screen if the presenter does not want to share such windows.

What is needed is an improved method for sharing applications during a data conference.

### SUMMARY

In one embodiment, the invention includes: detecting a profile associated a presenter device wherein the profile indicates a hidden window; selectively sharing desktop content and excluding the hidden window with an attendee device wherein the desktop content corresponds with the presenter device; detecting a change in status of a content window within the desktop content; and updating the profile based on the change in status of the content window.

### BRIEF DESCRIPTION OF THE DRAWINGS

For a more complete understanding of the present invention and for further embodiments, aspects, and advantages, reference is now made to the following description taken in conjunction with the accompanying drawings, in which:

FIG. 1 is a block diagram of an exemplary data conferencing system, according to some embodiments of the present invention.

FIG. 2 is a flowchart of an exemplary application based screen sampling method, according to some embodiments of the present invention.

FIGS. 3A and 3B show a presenter's computer screen and a viewer's computer screen, respectively, during a data conference, according to some embodiments of the present invention.

FIG. 4 is a flowchart of an exemplary OpenGL application based screen sampling method, according to some embodiments of the present invention.

FIGS. 5A and 5B show a presenter's computer screen and a viewer's computer screen, respectively, during a data conference, according to some embodiments of the present invention.

FIG. 6 is a flowchart of an exemplary DirectDraw application based screen sampling method, according to some embodiments of the present invention.

FIGS. 7A and 7B show a presenter's computer screen and a viewer's computer screen, respectively, during a data conference, according to some embodiments of the present invention.

FIG. 8 is a simplified block diagram illustrating a system, consistent with one embodiment of the invention.

FIG. 9 is an exemplary record for use with the invention.

FIGS. 10, 11, 12, and 13 are flow diagrams consistent with one embodiment of the invention.

FIGS. 14A, 14B, 15A, 15B, 16A, and 16B illustrate an exemplary desktop showing one embodiment of the invention.

### DETAILED DESCRIPTION OF THE INVENTION

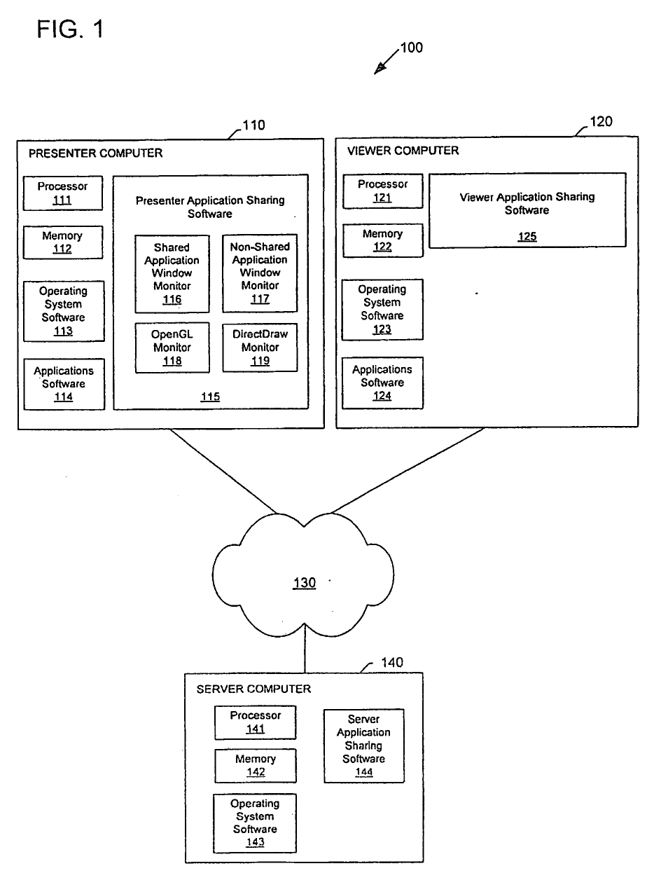

The preferred embodiments of the present invention and their advantages are best understood by referring to FIGS. 1 through 16 of the drawings. Like reference numerals are used for like and corresponding components of the various drawings. As used herein, the term shared application window refers to a window belonging to an application that a presenter intends to share with a viewer, and the term non-shared application window refers to a window belonging to an application that a presenter does not intend to share with a viewer.

References to a device include a device utilized by a user such as a desktop computer, a portable computer, a personal digital assistant, a video phone, a landline telephone, a cellular telephone, and a device capable of receiving/transmitting an electronic signal.

References to content include audio, video, graphical, and/or textual data.

References to a window are directed to an area utilized to display the content.

References to a desktop are directed to an entire portion of a display area of a corresponding device.

References to a collaboration session include a plurality of devices that are configured to view content submitted by one of the devices.

References to a participant device include devices that are participating in the collaboration session.

References to a presenter device include a device that is participant and shares content shared with other participants.

References to an attendee device include a device that is a participant and receives content shared by another participant device. The attendees are capable of view content that is offered by the presenter device. In some instances, the attendee devices are capable of modifying the content shared by the presenter device.

Data Conferencing System

FIG. 1 is a block diagram of an exemplary data conferencing system 100, according to some embodiments of the present invention. A presenter computer 110 is connected to a server computer 140 via a global area computer network 130. A viewer computer 120 is connected to server computer 140 via global area computer network 130. A presenter can use presenter computer 110 to connect to server computer 140. Once connected, the presenter can start a data conference. A viewer can use viewer computer 120 to connect to server computer 140. Once connected, the viewer can join the data conference started by the presenter. Once the data conference has been established, the presenter can, among other things, share applications with the viewer. For clarity, system 100 is depicted with only a single presenter computer 110, a single viewer computer 120, and a single server computer 140. It should be recognized, however, that multiple presenter computers 110, multiple viewer computers 120, and multiple server computers 140 can be used with the present invention. It should also be recognized that presenter computer 110 and/or viewer computer 120 can be any type of electronic devices that are capable of communicating with one another and displaying an image on a screen. For example, presenter computer 110 and/or viewer computer 120 can be personal digital assistants (PDAs), cellular telephones, or other like devices.

Presenter computer 110 includes processor 111, memory 112, operating system software 113, applications software 114, and presenter application sharing software 115. Processor 111 can be any suitable processor, such as a member of the Pentium family of processors. Memory 112 can be any type of suitable memory, such as DRAM, SRAM, a magnetic hard drive, an optical hard drive, or any combination thereof. Operating system software 113 can be any type of suitable operating system software, such as Microsoft Windows-based operating system software. Applications software 114 can be a word processing application, a spreadsheet application, a computer aided drafting application, or any other type of application.

Presenter application sharing software 115 can be any type of suitable software that enables presenters and viewers to share applications, documents, or the like. Presenter application sharing software 115 includes the following software components: shared application window monitor 116, non-shared application window monitor 117, OpenGL monitor 118, and DirectDraw monitor 119. The function of each of these software components is discussed in detail below. Presenter application sharing software 115 also includes other software components that are not shown or discussed for clarity. An example of presenter application sharing software 115 is a downloadable plug-in provided by WebEx Communications, Inc. of San Jose, Calif.

Viewer computer 120 includes processor 121, memory 122, operating system software 123, and applications software 124, which are similar to processor 111, memory 112, operating system software 113, and applications software 114, of presenter computer 110. Viewer computer 120 also includes viewer application sharing software 125, which can be similar to or the same as presenter application sharing software 115. Viewer application sharing software 125, among other things, receives images of application windows from the presenter's computer and displays the images on the viewer's computer screen.

Server computer 140 includes a processor 141, memory 142, operating system software 143 and server application sharing software 144. Server application sharing software 144 can be any type of suitable software that allows presenters and viewers to conduct data conferences.

Details of data conferencing system 100 are further described in the following United States patent applications and patents, each of which is incorporated herein by reference in its entirety: “Distributed Network System Architecture For Collaborative Computing,” co-pending and commonly-assigned application for a U.S. patent Ser. No. 09/751,424, filed Dec. 29, 2000; “Fault-Tolerant Distributed System For Collaborative Computing,” co-pending and commonly-assigned application for a U.S. patent Ser. No. 09/751,807, filed Dec. 29, 2000; “Scalable Distributed System For Collaborative Computing,” co-pending and commonly-assigned application for a U.S. patent Ser. No. 09/751,548, filed Dec. 29, 2000; “Distributed Meeting Management,” co-pending and commonly-assigned application for a U.S. patent Ser. No. 09/751,595, filed Dec. 29, 2000; “Fault Tolerant Server Architecture For Collaborative Computing,” co-pending and commonly-assigned application for a U.S. patent Ser. No. 09/752,376, filed Dec. 29, 2000; “Distributed Application Sharing,” co-pending and commonly-assigned application for a U.S. patent Ser. No. 09/751,806, filed Dec. 29, 2000; “Distributed Document Sharing,” co-pending and commonly-assigned application for a U.S. patent Ser. No. 09/753,193, filed Dec. 29, 2000; “Secure Communications System For Collaborative Computing,” co-pending and commonly-assigned application for a U.S. patent Ser. No. 09/752,284, filed Dec. 29, 2000; “Fault Tolerant Server For Collaborative Computing,” co-pending and commonly-assigned application for a U.S. patent Ser. No. 09/751,519, filed Dec. 29, 2000; “Quality Of Service Maintenance For Distributed Collaborative Computing,” co-pending and commonly-assigned application for a U.S. patent Ser. No. 09/752,377, filed Dec. 29, 2000; “Instant Document Sharing,” co-pending and commonly-assigned application for a U.S. patent Ser. No. 09/442,424, filed Nov. 17, 1999; “Instant Sharing of Documents in a Viewer Server,” co-pending and commonly-assigned application for U.S. patent Ser. No. 09/471,938, filed Dec. 23, 1999; “Viewer Document Serving,” co-pending and commonly-assigned application for a U.S. patent Ser. No. 09/591,377, filed Jun. 9, 2000; “Instantaneous Viewer Control of an Unattended Server,” co-pending and commonly-assigned application for a U.S. patent Ser. No. 09/515,684, filed Feb. 29, 2000; “Method for Creating Peer-to-Peer Connections Over an Interconnected Network to Facilitate Conferencing Among Users,” co-pending and commonly-assigned application for a U.S. patent Ser. No. 08/609,025, filed on Feb. 29, 1996; “Method for Establishing a Communication Connection Between Two or More Users Via a Network of Interconnected Computers,” co-pending and commonly-assigned application for a U.S. patent Ser. No. 09/195,801, filed on May 12, 2000; “Emulating a Persistent Connection Using HTTP,” co-pending and commonly-assigned application for a U.S. patent Ser. No. 09/449,011, filed on Nov. 24, 1999; “Method of Transferring Data at Adjustable Levels of Priorities to Provide Optimum Response to User Demands,” U.S. Pat. No. 5,623,603; “Method to Provide for Virtual Screen Overlay,” U.S. Pat. No. 5,577,188; and “Collaborative Web Browser,” U.S. Pat. No. 5,944,791.

Application Based Screen Sampling

The present invention provides an improved method for sharing applications during a data conference. As mentioned above, conventional application sharing techniques capture a predefined portion of the presenter's computer screen (e.g., the entire screen or a rectangle within the entire screen) and provide the image within the predefined portion of the presenter's computer screen to the viewer. All of the applications that have windows positioned within the predefined portion of the presenter's computer screen are captured by the presenter's computer, transmitted to the viewer's computer, and displayed on the viewer's computer screen whether or not the presenter intended to share these application windows with the viewer. As a result, the presenter may inadvertently share an application window with a viewer that the presenter does not intend to share with the viewer. As described below, the application sharing method of the present invention overcomes these disadvantages.

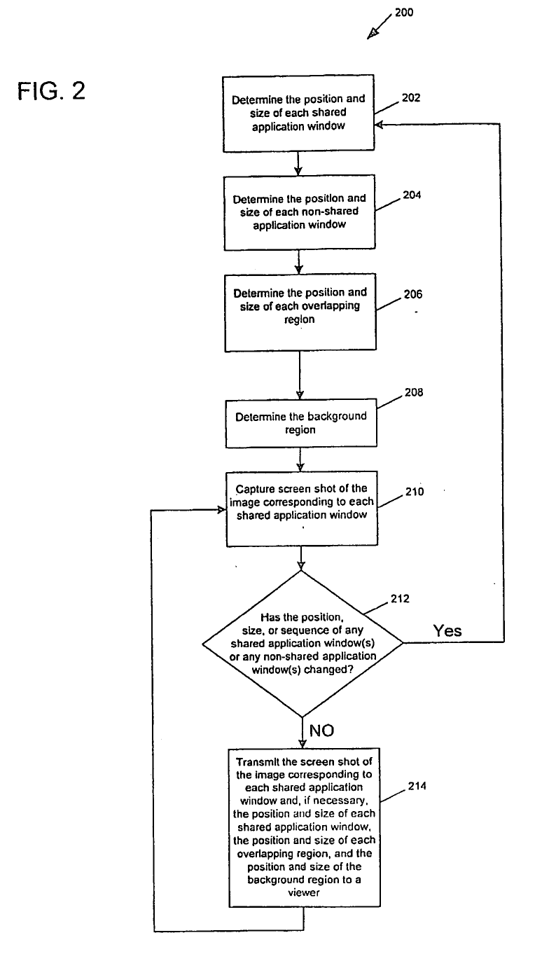

FIG. 2 is a flowchart of an exemplary application based screen sampling method 200, according to some embodiments of the present invention. Method 200 is performed during a data conference. Method 200 assumes that the presenter has pre-defined or pre-designated an application as a shared application during the data conference.

In step 202, the position and the size of each shared application window is determined. If the shared application only has one window, the position and size of this window is determined. If the shared application has several windows, the position and size of each of these windows is determined.

The position and size of each shared application window can be determined dynamically by monitoring and intercepting function calls made by the shared application to a graphics display subsystem. The graphics display subsystem receives the function calls and, in response, causes appropriate graphics or images to be drawn on the presenter's computer screen. For example, if the application is running on a Microsoft Windows based computer, the application may call Graphics Device Interface (GDI) functions to draw images on the presenter's computer screen. The function calls provide information that identifies which application a particular window belongs to, the position of the window, and the size of the window. Thus, by monitoring and intercepting the function calls, the position and size of a window can be determined. This step can be performed by shared application window monitor 116 (FIG. 1).

If the presenter's computer is operating in a Windows environment, the position and size of each shared application window can be determined by monitoring the “GetRandomRgn” function. The GetRandomRgn function prototype is as follows:

int GetRandomRgn (HDC hdc, HRGN hrgn, INT iNum)

Microsoft Corp. first published the GetRandomRgn function prototype with the release of Windows 2000. However, in this publication Microsoft Corp. did not provide a definition for iNum. The publication stated that iNum must be SYSRGN (a predefined value). Applicant has discovered that, by setting inum to the value 4, the visible region of a window can be determined. For example, the following process can be used to determine the visible region of a hypothetical window hWnd:

HDC hdc=GetWindowDC(hWnd) 11 of the window Get the graphic context

HRGN hRegion=CreateRectRgn (0, 0, 0, 0) 11 Create an empty region

GetRandomRgn (hDC, hRegion, 4) 11 hRegion is now the visible region of the window

In step 204, the position and the size of each non-shared application window is determined. If the non-shared application only has one window, the position and size of this window is determined. If the non-shared application has several windows, the position and size of each of these windows is determined.

The position and size of each non-shared application window can be determined dynamically by monitoring and intercepting function calls made by the non-shared application to a graphics display subsystem (as described in step 202 above). This step can be performed by non-shared application window monitor 117 (FIG. 1).

In step 206, the position and size of each overlapping region is determined. An overlapping region is a region on the presenter's computer screen where a non-shared application window overlaps a shared application window. If none of the non-shared application windows overlap shared application windows, there are no overlapping regions. If multiple non-shared application windows overlap shared application windows, there are multiple overlapping regions.

The position and size of each overlapping region can be determined by comparing the position and size of each shared application window with the position and size of each non-shared application window.

In step 208, the background region is determined. The background region is the area on the presenter's computer screen that is not occupied by a shared application window. The background region includes areas of the presenter's computer screen that are occupied by non-shared application windows.

The background region can be determined by comparing the position and size of each shared application window with the position and size of the presenter's entire computer screen.

In step 210, a screen shot of the image corresponding to each shared application window is captured. In this step, the image within each shared application window is captured so that it can be provided to the viewer. This step is performed periodically (e.g., five times per second) so that changes to the image on the presenter's computer screen are immediately reflected on the viewer's computer screen.

The screen shot of the image corresponding to each shared application window can be captured by capturing portions of the frame buffer on the presenter's computer that correspond to shared application windows. Since step 202 determines the sizes and positions of the shared application windows, the location of the shared application windows within the frame buffer are known.

In step 212, the position, size, and sequence of each shared application window and each non-shared application window is monitored. If the position, size, or sequence of a shared application window or a non-shared application window changes, then method 200 returns to step 202. If the position, size, and sequence of the shared application windows and the non-shared application windows do not change, then method 200 proceeds to step 214.

The position, size, and sequence of each shared application window and each non-shared application window on the presenter's computer screen can be dynamically monitored by monitoring and intercepting function calls made by the shared and non-shared applications to a graphics display subsystem (as described in step 202 above).

In step 214, the screen shot of the image corresponding to each shared application window and, if necessary, the position and size of each shared application window, the position and size of each overlapping region, and the position and size of the background region is transmitted to the viewer's computer. If the position, size, and sequence of the shared application windows and the non-shared application windows have not changed since the previous screen shot was transmitted to the viewer's computer, then the position and size of the shared application windows, the position and size of the overlapping regions, and the position and size of the background region do not have to be retransmitted to the viewer's computer. On the other hand, if the position, size, or sequence of the shared application windows or the non-shared application windows have changed since the previous screen shot was transmitted to the viewer's computer, then the updated position and size of the shared application windows, the updated position and size of the overlapping regions, and/or the updated position and size of the background region are transmitted to the viewer's computer. This ensures that the viewer's computer screen accurately reflects what is currently displayed on the presenter's computer screen. Prior to transmission, the screen shot of the images corresponding to each shared application window can be compressed using image compression techniques such as GZIP or JPEG.

Once the viewer's computer has received the screen shot of the image corresponding to each shared application window, and if transmitted, the position and size of each shared application window, the position and size of each overlapping region, and the position and size of the background region, viewer application sharing software 125 can display the image on the viewer's computer screen. To accomplish this, viewer application software 125 performs the following process. First, viewer application software 125 generates or draws a background region based on the position and size of the background region. The background region can be filled or painted with an arbitrary color or image. Second, viewer application software 125 generates or draws a window corresponding to the position and size of each shared application window. Third, viewer application sharing software 125 generates or draws the image corresponding to each shared application window inside of each shared application window. Fourth, viewer application software 125 generates or draws an overlapping region corresponding to the position and size of each overlapping region. The overlapping region can be filled or painted with an arbitrary color or image. Skilled artisans will recognize that this process can be modified to achieve the same result and that all such modifications are within the scope of the present invention.

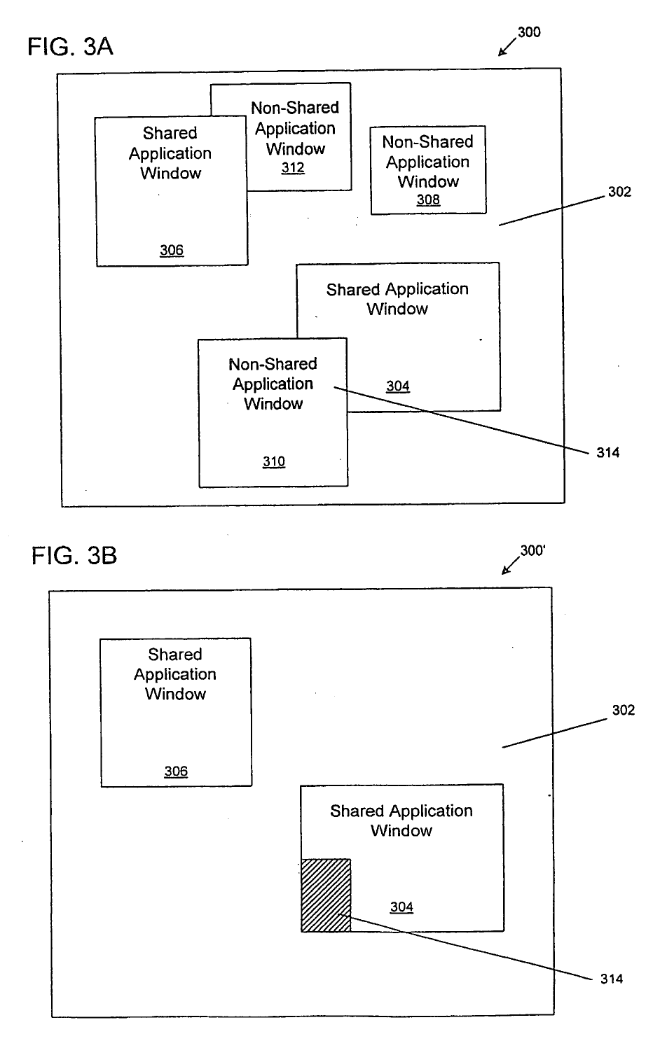

FIGS. 3A and 3B show an example of how application based screen sampling method 200 operates during a data conference. FIG. 3A shows a presenter's computer screen 300. Presenter's computer screen 300 includes background region 302, shared application windows 304 and 306, non-shared application windows 308, 310, and 312, and overlapping region 314. FIG. 3B shows a viewer's computer screen 300′. Viewer's computer screen 300′ includes background region 302, shared application windows 304 and 306, and overlapping region 314.

After a data conference has started, the presenter selects one or more applications to share with a viewer. Presenter application sharing software 115 receives the presenter's selections and then performs the application based sharing method of the present invention as follows. First, presenter application sharing software 115 determines the position and size of each shared application window on the presenter's computer screen 300 (step 202). To accomplish this, shared application window monitor 116 monitors appropriate function calls that define the positions and sizes of shared application windows 304 and 306. Second, presenter application sharing software 115 determines the position and size of each non-shared application window on the presenter's computer screen 300 (step 204). To accomplish this, non-shared application window monitor 117 monitors appropriate function calls that define the position and size of non-shared application windows 308, 310, and 312. Third, presenter application sharing software 115 determines the position and size of the overlapping regions (step 206). Presenter application sharing software 115 can determine this by comparing the position and size of shared application window 304 with the position and size of non-shared application window 310. Note that the portion of shared application window 306 that overlaps non-shared application window 312 is not an overlapping region since non-shared application window 312 does not overlap shared application window 306. Fourth, presenter application sharing software 115 determines the background region 302 (step 208). Presenter application sharing software 115 can determine the background region by comparing the positions and sizes of shared application windows 304 and 306 with the position and size of the entire computer screen 300. Fifth, presenter application sharing software 115 captures a screen shot of image within shared application windows 304 and 306 (step 210). Presenter application sharing software 115 can perform this step by capturing a screen shot that corresponds to the position and size of shared application windows 304 and 306. Sixth, presenter application sharing software 115 determines whether the position, size, or sequence of any shared application windows or of any non-shared application windows has changed (step 212). Presenter application sharing software 115 can perform this step by monitoring function calls that define the position, size, and sequence of shared application windows 304 and 306 and non-shared application windows 308, 310, and 312. Since the position, size and sequence of the shared application windows and the non-shared application windows have not changed in this example, the presenter application sharing software 115 proceeds to the next step in the process (i.e., step 214). Seventh, presenter application sharing software 115 transmits the screen shot of the image within shared application windows 304 and 306, and, if necessary, the position and size of shared application windows 304 and 306, the position and size of overlapping region 314, and position and size of the background region 302 (step 214). This example assumes that the position and size of shared application windows 304 and 306, the position and size of overlapping region 314, and position and size of background region 312 do not change. Thus the position and size of shared application windows 304 and 306, the position and size of overlapping region 312, and position and size of the background region 302 only need to be transmitted to the viewer's computer once. After that, only the updated screen shots of image within shared application windows 304 and 306 on the presenter's computer screen need to be periodically transmitted to the viewer's computer.

Application based screen sampling method 200 provides at least the following advantages. First, it allows a presenter to define or designate applications as shared applications and non-shared applications. Windows belonging to shared applications and non-shared applications are monitored and only windows belonging to shared application are displayed on a viewer's computer screen. Thus the presenter does not have to worry about inadvertently sharing an application window or a portion of an application window that the presenter does not intend to share with a viewer. Second, the presenter can now intentionally obscure a portion of a shared application window by placing a non-shared application window over the shared application window.

OpenGL Application Based Screen Sampling

The present invention provides an improved method for sharing applications that use OpenGL during a data conference. OpenGL is a well-known application program interface (API) that is used by applications to draw graphics (e.g., 2D and 3D graphics) on a presenter's computer screen. To generate graphics using OpenGL, an application first launches OpenGL. The application then calls OpenGL functions. As a result of these function calls, OpenGL internally calls glFlash, glDraw, and/or glEscape, which are OpenGL subsystems. Finally, the glFlash, glDraw, or glEscape subsystems cause the graphics to be drawn on the presenter's computer screen.

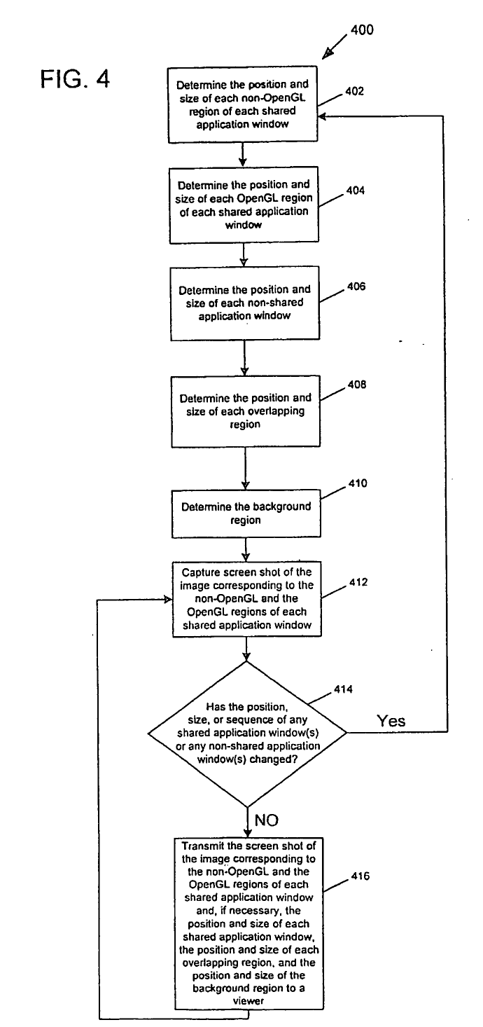

FIG. 4 is a flowchart of an exemplary OpenGL application based screen sampling method 400, according to some embodiments of the present invention. Method 400 is performed during a data conference. Method 400 assumes that the presenter has pre-defined or pre-designated an application as a shared application during the data conference.

In step 402, the position and size of each non-OpenGL region of each shared application window is determined. The non-OpenGL regions are the areas within shared application windows that are not drawn by OpenGL. If the shared application only has one window, the position and size of the non-OpenGL regions in this window are determined. If the shared application has several windows, the position and size of the non-OpenGL regions in each of these windows is determined.

The position and size of each non-OpenGL region of each shared application window can be determined dynamically by monitoring and intercepting function calls made by the shared application to a graphics display subsystem (as described in step 202 above).

In step 404, the position and size of each OpenGL region of each shared application window is determined. The OpenGL regions are the areas within the shared application windows that are drawn by OpenGL. If the shared application only has one window, the position and size of the OpenGL regions in this window are determined. If the shared application has several windows, the position and size of the OpenGL regions in each of these windows are determined.

The position and size of the OpenGL regions of each shared application window can be determined dynamically by monitoring and intercepting OpenGL function calls made by the application. For example, the position and size of the OpenGL regions of each window belonging to a shared application can be determined dynamically by monitoring and intercepting function calls to the glFlash, glDraw, and glEscape subsystems of OpenGL. Thus, by monitoring and intercepting the function calls made to OpenGL or to the glFlash, glDraw, and/or glEscape subsystems of OpenGL, the position and size of each OpenGL region within a shared application window can be determined. This step can be performed by OpenGL monitor 118 (FIG. 1).

In step 406, the position and size of each non-shared application window is determined. If the non-shared application only has one window, the position and size of this window is determined. If the non-shared application has several windows, the position and size of each of these windows are determined.

The position and size of the non-shared application windows can be determined dynamically by monitoring and intercepting function calls made by the shared application to a graphics display subsystem (as described in step 202 above).

In step 408, the position and size of each overlapping region is determined. An overlapping region is a region on the presenter's computer screen where a non-shared application window overlaps a non-OpenGL region or an OpenGL region of a shared application window. If none of the non-shared application windows overlap non-OpenGL regions or OpenGL regions of shared application windows, there are no overlapping regions. If multiple non-shared application windows overlap non-OpenGL regions or OpenGL regions of shared application windows, there are multiple overlapping regions.

The position and size of each overlapping region can be determined by comparing the position and size of the non-OpenGL and the OpenGL regions of each shared application window with the position and size of each non-shared application window.

In step 410, the background region is determined. The background region is the area on the presenter's computer screen that is not occupied by a shared application window (i.e., not a non-OpenGL or OpenGL region). The background region includes areas of the presenter's computer screen that are occupied by non-shared application windows.

The background region can be determined by comparing the position and size of the non-OpenGL and the OpenGL regions of each shared application window with the position and size of the presenter's entire computer screen.

In step 412, a screen shot of the image corresponding to the non-OpenGL and OpenGL regions of each shared application windows is captured. In this step, the image within each shared application window (i.e., the non-OpenGL and OpenGL regions) is captured so that it can be provided to the viewer. This step is performed periodically (e.g., five times per second). Thus, as the image on the presenter's computer screen changes, these changes are immediately reflected on the viewer's computer screen.

The screen shot of the image corresponding to non-OpenGL and OpenGL regions can be captured by capturing portions of the frame buffer on the presenter's computer that correspond to the non-OpenGL and OpenGL regions. Since step 402 and 404 determines the sizes and positions of the non-OpenGL and OpenGL regions of shared application windows, the location of the shared application windows within the frame buffer are known.

In step 414, the position, size, and sequence of each shared application window and each non-shared application window is monitored. If the position, size, or sequence of a shared application window or a non-shared application window changes, then method 400 returns to step 402. If the position, size, and sequence of the shared application windows and the non-shared application windows do not change, then method 400 proceeds to step 412.

The position, size, and sequence of each shared application window and each non-shared application window on the presenter's computer screen can be dynamically monitored by monitoring and intercepting function calls made by the shared application to a graphics display subsystem (as described above).

In step 416, the screen shot of the image corresponding to the non-OpenGL and the OpenGL regions of each shared application window, if necessary, the position and size of each shared application window, the position and size of each overlapping region, and the position and size of the background region is transmitted to the viewer's computer. If the position, size, and sequence of the shared application windows and the non-shared application windows have not changed since the previous screen shot was transmitted to the viewer's computer, then the position and size of the shared application windows, the position and size of the overlapping regions, and the position and size of the background region do not have to be retransmitted to the viewer's computer. On the other hand, if the position, size, or sequence of the shared application windows or the non-shared application windows have changed since the previous screen shot was transmitted to the viewer's computer, then the updated position and size of the shared application windows, the updated position and size of the overlapping regions, and/or the updated position and size of the background region are transmitted to the viewer's computer. This ensures that the viewer's computer screen accurately reflects what is currently displayed on the presenter's computer screen. Prior to transmission, the screen shot of the images corresponding to each shared application window can be compressed using image compression techniques such as GZIP or JPEG.

Once the viewer's computer has received the screen shot of the image corresponding to the non-OpenGL and the OpenGL regions of each shared application window, and if transmitted, the position and size of each shared application window, the position and size of each overlapping region, and the position and size of the background region, viewer application sharing software 125 can display the image on the viewer's computer screen. To accomplish this, viewer application software 125 performs the following process. First, viewer application software 125 generates or draws a background region based on the position and size of the background region. The background region can be filled or painted with an arbitrary color or image. Second, viewer application software 125 generates or draws a window corresponding to the position and size of each shared application window. Third, viewer application sharing software 125 generates or draws the image corresponding to the non-OpenGL and the OpenGL regions of each shared application window inside of each shared application window. Fourth, viewer application software 125 generates or draws an overlapping region corresponding to the position and size of each overlapping region. The overlapping region can be filled or painted with an arbitrary color or image. Skilled artisans will recognize that this process can be modified to achieve the same result and that all such modifications are within the scope of the present invention.

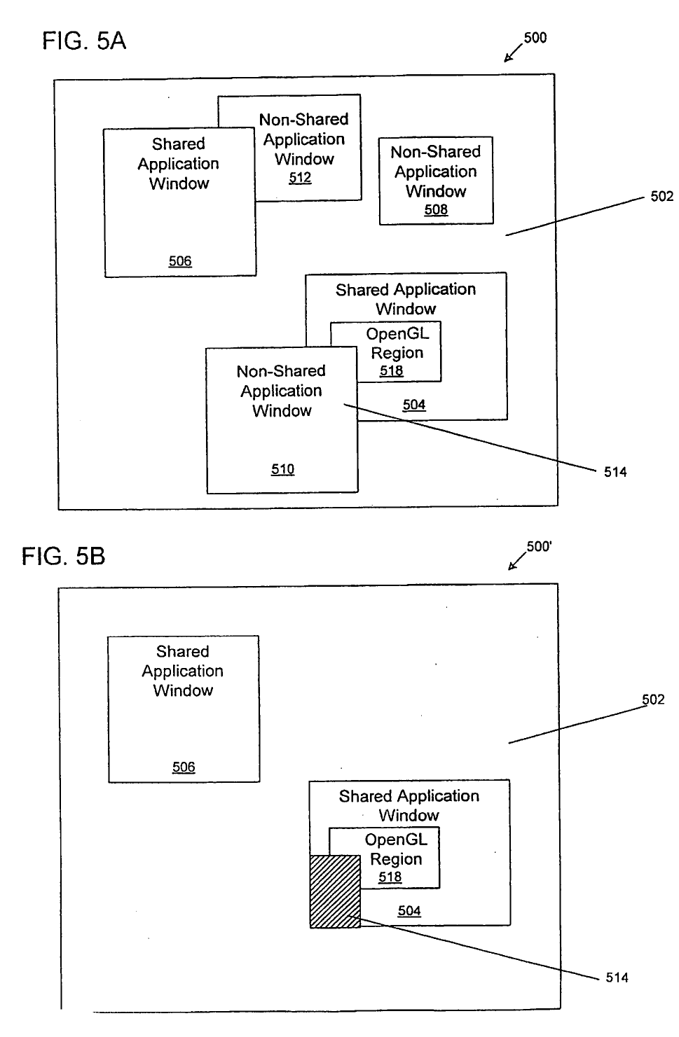

FIGS. 5A and 5B show an example of how application based screen sampling method 400 operates during a data conference. FIG. 5A shows a presenter's computer screen 500. Presenter's computer screen 500 includes background region 502, shared application windows 504 and 506, non-shared application windows 508, 510, and 512, and overlapping region 514. Shared application window 504 includes an OpenGL region 518, which is a region drawn by OpenGL. The region of shared application window 504 outside of OpenGL region 518 is referred to as the non-OpenGL region, which is a region that is not drawn by OpenGL. FIG. 5B shows a viewer's computer screen 500′. Viewer's computer screen 500′ includes background region 502, shared application windows 504 and 506, and overlapping region 514. Shared application window 504 includes OpenGL region 518. A portion of OpenGL region 518 and non-OpenGL region of shared application window 504 is obscured by overlapping region 514.

After a data conference has started, the presenter selects one or more applications to share with a viewer. Presenter application sharing software 115 receives the presenter's selections and then performs the OpenGL application based sharing method of the present invention as follows. First, presenter application sharing software 115 determines the position and size of the non-OpenGL regions within each shared application window on the presenter's computer screen 500 (step 402). To accomplish this, shared application window monitor 116 monitors function calls that define the positions and sizes of the non-OpenGL regions of shared application windows 504 and 506. Second, presenter application sharing software 115 determines the position and size of the OpenGL regions within each shared application window on the presenter's computer screen 500 (step 404). To accomplish this, OpenGL monitor 118 monitors OpenGL function calls made by the application that define the positions and sizes of the OpenGL regions of shared application window 504. Third, presenter application sharing software 115 determines the position and size of each non-shared application window on the presenter's computer screen 500 (step 406). To accomplish this, non-shared application window monitor 117 monitors function calls that define the positions and sizes of non-shared application windows 508, 510, and 512. Fourth, presenter application sharing software 115 determines the position and size of the overlapping regions (step 408). Presenter application sharing software 115 can determine the overlapping regions by comparing the position and size of non-OpenGL regions and the OpenGL regions of shared application window 504 with the position and size of non-shared application window 510. Note that the portion of shared application window 506 that overlaps non-shared application window 512 is not an overlapping region since non-shared application window 512 does not overlap shared application window 506. Fifth, presenter application sharing software 115 determines the background region 502 (step 410). Presenter application sharing software 115 can determine the background region by comparing the positions and sizes of shared application windows 504 and 506 with the position and size of the entire computer screen 500. Sixth, presenter application sharing software 115 captures a screen shot of the image within non-OpenGL and the OpenGL regions of the shared application windows (step 412). Presenter application sharing software 115 can perform this step by capturing a screen shot of the image that corresponds to the position and size of shared application windows 504 and 506 (including the non-OpenGL and the OpenGL regions). Seventh, presenter application sharing software 115 determines whether the position, size or sequence of any shared application windows or any non-shared application windows have changed (step 414). Presenter application sharing software 115 can perform this step by monitoring function calls that define the position, size, and sequence of shared application windows 504 and 506 and non-shared application windows 508, 510, and 512. Since the position, size and sequence of the shared application windows and the non-shared application windows have not changed in this example, the presenter application sharing software 115 proceeds to the next step of the process (i.e., step 416). Eighth, presenter application sharing software 115 transmits the screen shots of the image within non-OpenGL and the OpenGL regions of shared application windows 504 and 506, and, if necessary, the position and size of shared application windows 504 and 506, the position and size of overlapping region 514, and position and size of background region 502 (step 416). This example assumes that the position and size of shared application windows 504 and 506, the position and size of overlapping region 514, and position and size of background region 502 do not change. Thus the position and size of shared application windows 504 and 506, the position and size of overlapping region 508, 510, and 512, and position and size of background region 502 only need to be transmitted to the viewer's computer once. After that, only the updated screen shots of the image within shared application windows 504 and 506 on the presenter's computer screen need to be periodically transmitted to the viewer's computer.

Application based screen sampling method 400 provides at least the following advantages. First, it allows a presenter to define or designate applications as shared applications and non-shared applications. Windows belonging to shared applications and non-shared applications are monitored and only windows belonging to shared application windows are displayed on a viewer's computer screen. Thus the presenter does not have to worry about inadvertently sharing an application window or a portion of an application window that the presenter does not intend to share with a viewer. Second, the presenter can now intentionally obscure a portion of a shared application window by placing a non-shared application window over the shared application window. Third, the presenter can share applications that generate images using OpenGL.

DirectDraw Application Based Screen Sampling

The present invention provides an improved method for sharing applications that use DirectDraw during a data conference. DirectDraw is a well-known Windows-based API used to create 2graphics. Many applications use DirectDraw to draw graphics on a presenter's computer screen. Unlike OpenGL and other general windows APIs, DirectDraw is COM based. To generate graphics using DirectDraw, an application first launches DirectDraw. The application then gets the COM interfaces corresponding to DirectDraw. Next, the application calls the DirectDraw COM interface to access the DirectDraw functions. Finally, the DirectDraw COM interface calls an internal function to render the graphics.

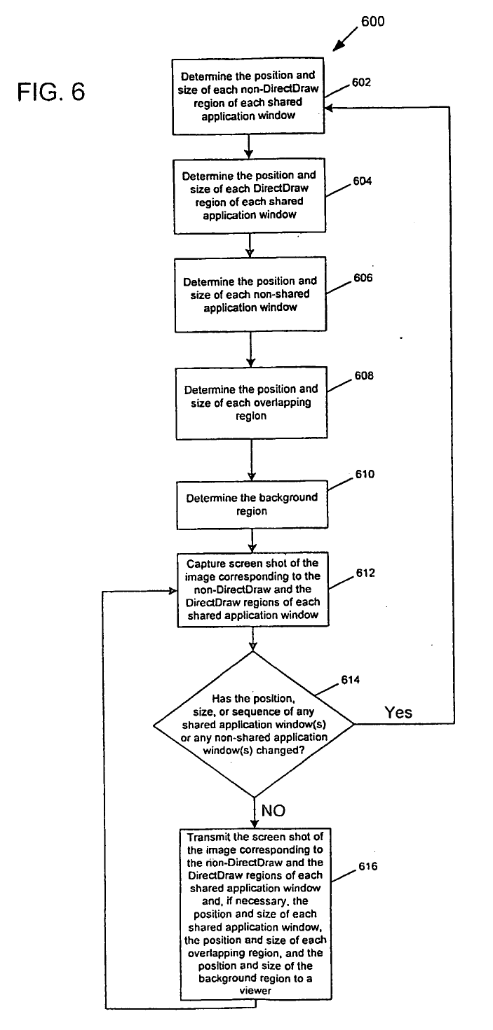

FIG. 6 is a flowchart of an exemplary DirectDraw application based screen sampling method 600, according to some embodiments of the present invention.

Method 600 is performed during a data conference. Method 600 assumes that the presenter has pre-defined or pre-designated an application as a shared application during the data conference.

In step 602, the position and size of each non-DirectDraw region of each shared application window is determined. The non-DirectDraw regions are the areas within shared application windows that are not drawn by DirectDraw. If the shared application only has one window, the position and size of the non-DirectDraw regions in this window are determined. If the shared application has several windows, the position and size of the non-DirectDraw regions in each of these windows are determined.

The position and size of each non-DirectDraw regions of each shared application window can be determined dynamically by monitoring and intercepting function calls made by the shared application to a graphics display subsystem (as described in step 202 above).

In step 604, the position and size of each DirectDraw region of each shared application window is determined. The DirectDraw regions are the areas within the shared application windows that are drawn by DirectDraw. If the shared application only has one window, the position and size of the DirectDraw regions in this window are determined. If the shared application has several windows, the position and size of the DirectDraw regions in each of these windows are determined.

The position and size of each DirectDraw region of each shared application window can be determined by monitoring the DirectDraw COM interface. As mentioned above, DirectDraw is not like OpenGL and other general windows APIs; DirectDraw is COM based. Since Direct Draw is COM based, it is not possible to monitor function calls made by the application directly to DirectDraw to determine the position and size of each DirectDraw region of each shared application window. However, Applicant has discovered that the position and size of each DirectDraw region of each shared application window can be determined by dynamically monitoring the, DirectDraw COM interface and intercepting information that defines the position and size of each DirectDraw region of each shared application window. This step can be performed by DirectDraw monitor 119 (FIG. 1).

In step 606, the position and size of each non-shared application window is determined. If the non-shared application only has one window, the position and size of this window is determined. If the non-shared application has several windows, the position and size of each of these windows are determined.

The position and size of the non-shared application windows can be determined dynamically by monitoring and intercepting function calls made by the shared application to a graphics display subsystem (as described in step 202 above).

In step 608, the position and size of each overlapping region is determined. An overlapping region is a region on the presenter's computer screen where a non-shared application window overlaps a non-DirectDraw region or a DirectDraw region of a shared application window. If none of the non-shared application windows overlap non-DirectDraw regions or DirectDraw regions of shared application windows, there are no overlapping regions. If multiple non-shared application windows overlap non-DirectDraw regions or DirectDraw regions of shared application windows, there are multiple overlapping regions.

The position and size of each overlapping region can be determined by comparing the position and size of the non-DirectDraw and the DirectDraw regions of each shared application window with the position and size of each non-shared application window.

In step 610, the background region is determined. The background region is the area on the presenter's computer screen that is not occupied by a shared application window (i.e., not a non-DirectDraw or DirectDraw region). The background region includes areas of the presenter's computer screen that are occupied by non-shared application windows.

The background region can be determined by comparing the position and size of the non-DirectDraw and the DirectDraw regions of each shared application window with the position and size of the presenter's entire desktop.

In step 612, a screen shot of the image corresponding to the non-DirectDraw and DirectDraw regions of each shared application windows is captured. In this step, the image within each shared application window (i.e., non-DirectDraw and DirectDraw regions) is captured so that it can be provided to the viewer. This step is performed periodically (e.g., five times per second). Thus, as the image on the presenter's computer screen changes, these changes are immediately reflected on the viewer's computer screen.

The screen shot of the image corresponding to non-DirectDraw and DirectDraw regions can be captured by capturing portions of the frame buffer on the presenter's computer that correspond to the non-DirectDraw and DirectDraw regions. Since step 602 and 604 determines the sizes and positions of the non-DirectDraw and DirectDraw regions of shared application windows, the location of the shared application windows within the frame buffer are known.

In step 614, the position, size, and sequence of each shared application window and each non-shared application window is monitored. If the position, size, or sequence of a shared application window or a non-shared application window changes, then method 600 returns to step 602. If the position, size, and sequence of the shared application windows and the non-shared application windows do not change, then method 600 proceeds to step 612.

The position, size, and sequence of each shared application window and each non-shared application window on the presenter's computer screen can be dynamically monitored by monitoring and intercepting function calls made by the shared application to a graphics display subsystem (as described above).

In step 616, the screen shot of the image within the non-DirectDraw and the DirectDraw regions of each shared application window, if necessary, the position and size of each shared application window, the position and size of each overlapping region, and the position and size of the background region is transmitted to the viewer's computer. If the position, size, or sequence of the shared application windows and the non-shared application windows have not changed since the previous screen shot was transmitted to the viewer's computer, then the position and size of the shared application windows, the position and size of the overlapping regions, and the position and size of the background region do not have to be retransmitted to the viewer's computer. On the other hand, if the position, size, or sequence of the shared application windows or the non-shared application windows have changed since the previous screen shot was transmitted to the viewer's computer, then the updated position and size of the shared application windows, the updated position and size of the overlapping regions, and/or the updated position and size of the background region are transmitted to the viewer's computer. This ensures that the viewer's computer screen accurately reflects what is currently displayed on the presenter's computer screen. Prior to transmission, the screen shot of the images corresponding to each shared application window can be compressed using image compression techniques such as GZIP or JPEG.

Once the viewer's computer has received the screen shot of the image corresponding to the non-DirectDraw and the DirectDraw regions of each shared application window, and if transmitted, the position and size of each shared application window, the position and size of each overlapping region, and the position and size of the background region, viewer application sharing software 125 can display the image on the viewer's computer screen. To accomplish this, viewer application software 125 performs the following process. First, viewer application software 125 generates or draws a background region based on the position and size of the background region. The background region can be filled or painted with an arbitrary color or image. Second, viewer application software 125 generates or draws a window corresponding to the position and size of each shared application window. Third, viewer application sharing software 125 generates or draws the image corresponding to the non-DirectDraw and the DirectDraw regions of each shared application window inside of each shared application window. Fourth, viewer application software 125 generates or draws an overlapping region corresponding to the position and size of each overlapping region. The overlapping region can be filled or painted with an arbitrary color or image. Skilled artisans will recognize that this process can be modified to achieve the same result and that all such modifications are within the scope of the present invention.

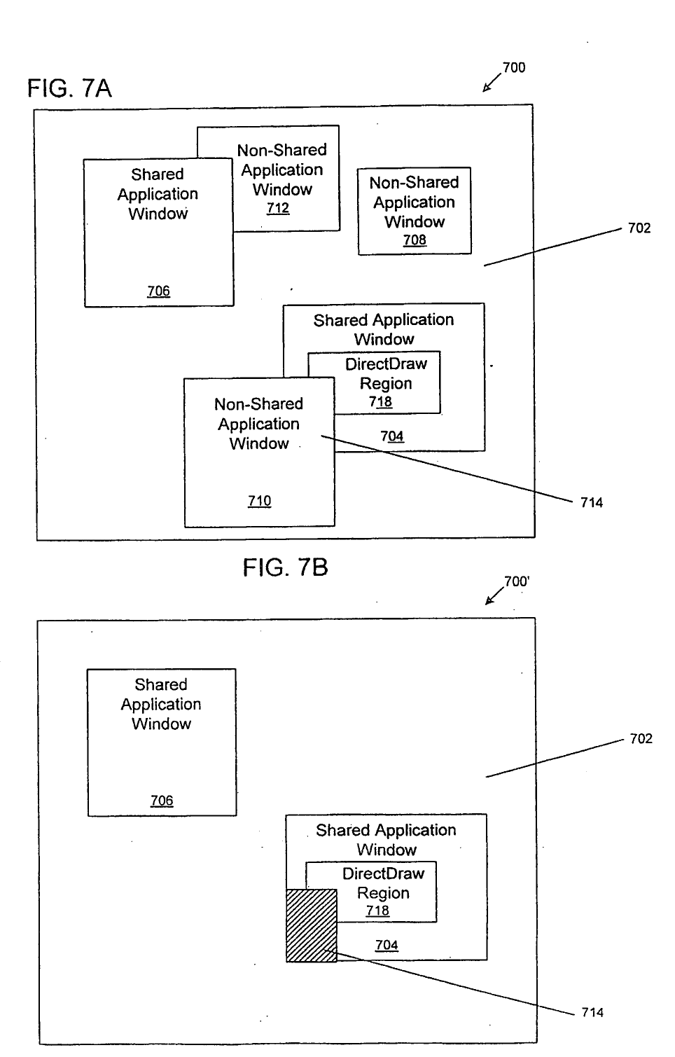

FIGS. 7A and 7B show an example of how application based screen sampling method 600 operates during a data conference. FIG. 7A shows a presenter's computer screen 700. Presenter's computer screen 700 includes background region 702, shared application windows 704 and 706, non-shared application windows 708, 710, and 712, and overlapping region 714. Shared application window 704 includes a DirectDraw region 718, which is a region drawn by DirectDraw. The region of shared application window 704 outside of DirectDraw region 718 is referred to as the non-DirectDraw region, which is a region that is not drawn by DirectDraw. FIG. 7B shows a viewer's computer screen 700′. Viewer's computer screen 700′ includes background region 702, shared application windows 704 and 706, and overlapping region 714. Shared application window 704 includes DirectDraw region 718. A portion of DirectDraw region 718 and non-DirectDraw region of shared application window 704 is obscured by overlapping region 714.

After a data conference has started, the presenter selects one or more applications to share with a viewer. Presenter application sharing software 115 receives the presenter's selections and then performs the DirectDraw application based sharing method of the present invention as follows. First, presenter application sharing software 115 determines the position and size of the non-DirectDraw regions within each shared application window on the presenter's computer screen 700 (step 602). To accomplish this, shared application window monitor 116 monitors function calls that define the positions and sizes of the non-DirectDraw regions of shared application windows 704 and 706. Second, presenter application sharing software 115 determines the position and size of the DirectDraw regions within each shared application window on the presenter's computer screen 700 (step 604). To accomplish this, DirectDraw monitor 118 monitors DirectDraw COM interface and intercepts information that defines the positions and sizes of the DirectDraw regions of shared application window 704. Third, presenter application sharing software 115 determines the position and size of each non-shared application window on the presenter's computer screen 700 (step 606). To accomplish this, non-shared application window monitor 117 monitors function calls that define the positions and sizes of non-shared application windows 708, 710, and 712. Fourth, presenter application sharing software 115 determines the position and size of the overlapping regions (step 608). Presenter application sharing software 115 can determine the overlapping regions by comparing the position and size of non-DirectDraw regions and the DirectDraw regions of shared application window 704 with the position and size of non-shared application window 710. Note that the portion of shared application window 706 that overlaps non-shared application window 712 is not an overlapping region since non-shared application window 712 does not overlap shared application window 706. Fifth, presenter application sharing software 115 determines the background region 702 (step 610). Presenter application sharing software 115 can determine the background region by comparing the positions and sizes of shared application windows 704 and 706 with the position and size of the entire computer screen 700. Sixth, presenter application sharing software 115 captures a screen shot of the image within non-DirectDraw and the DirectDraw regions of the shared application windows (step 612). Presenter application sharing software 115 can perform this step by capturing a screen shot of the image that corresponds to the position and size of shared application windows 704 and 706 (including the non-DirectDraw and the DirectDraw regions). Seventh, presenter application sharing software 115 determines whether the position, size or sequence of any shared application windows or any non-shared application windows have changed (step 614). Presenter application sharing software 115 can perform this step by monitoring function calls that define the position, size, and sequence of shared application windows 704 and 706 and non-shared application windows 708, 710, and 712. Since the position, size and sequence of the shared application windows and the non-shared application windows have not changed in this example, the presenter application sharing software 115 proceeds to step 216. Eighth, presenter application sharing software 115 transmits the screen shots of the image within non-DirectDraw and the DirectDraw regions of shared application windows 704 and 706, and, if necessary, the position and size of shared application windows 704 and 706, the position and size of overlapping region 714, and position and size of background region 702 (step 616). This example assumes that the position and size of shared application windows 704 and 706, the position and size of overlapping region 714, and position and size of background region 702 do not change. Thus the position and size of shared application windows 704 and 706, the position and size of overlapping region 714, and position and size of background region 702 only need to be transmitted to the viewer's computer once. After that, only the updated screen shots of the image within shared application windows 704 and 706 of the presenter's computer screen need to be periodically transmitted to the viewer's computer.

Application based screen sampling method 600 provides at least the following advantages. First, it allows a presenter to define or designate applications as shared applications and non-shared applications. Windows belonging to shared applications and non-shared applications are monitored and only windows belonging to shared application windows are displayed on a ‘viewer’s computer screen. Thus the presenter does not have to worry about inadvertently sharing an application window or a portion of an application window that the presenter does not intend to share with a viewer. Second, the presenter can now intentionally obscure a portion of a shared application window by placing a non-shared application window over the shared application window. Third, the presenter can share applications that generate images using DirectDraw.

It should also be recognized that step 604 of method 600 can be modified so that any COM interface (not just the DirectDraw COM interface) can be monitored. Thus, the present invention also provides general a method for monitoring any COM interface.

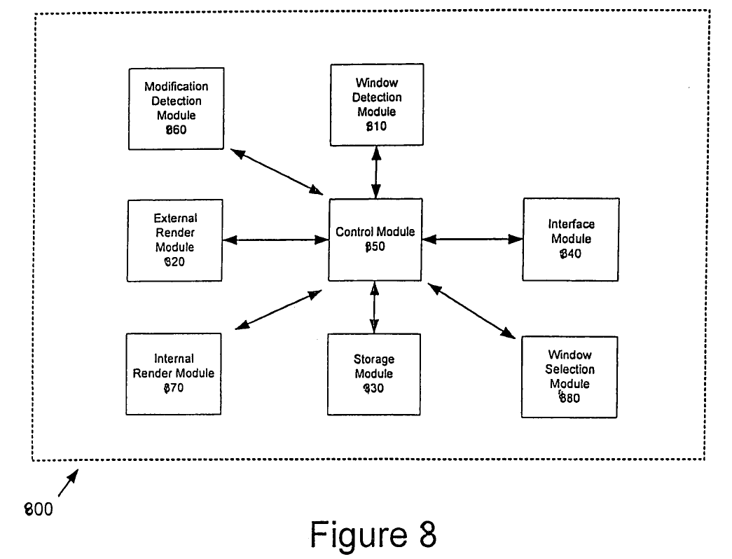

FIG. 8 illustrates one embodiment of a system 800. In one embodiment, the system 800 is embodied within the server 140. In another embodiment, the system 800 is embodied within the electronic device 110. In yet another embodiment, the system 800 is embodied within both the electronic device 110 and the server 140.

In one embodiment, the system 800 includes a window detection module 810, an external render module 820, a storage module 830, an interface module 840, a control module 850, a modification detection module 860, an internal render module 870, and a window selection module 880.

In one embodiment, the control module 850 communicates with the window detection module 810, the external render module 820, the storage module 830, the interface module 840, the modification detection module 860, the internal render module 870, and the window selection module 880. In one embodiment, the control module 850 coordinates tasks, requests, and communications between the window detection module 810, the external render module 820, the storage module 830, the interface module 840, the modification detection module 860, the internal render module 870, and the window selection module 880.

In one embodiment, the window detection module 810 detects a window that is utilized by a participant device that is acting as a presenter device. In one embodiment, the window is utilized to view content. In one embodiment, the window is utilized to view content that is part of the collaboration session. In another embodiment, the window is utilized to view confidential information. The window detection module 810 is configured to detect any number of windows utilized to display content within a desktop of the presenter device.

In one embodiment, the external render module 820 renders content for display on participant devices that are attendee devices of the collaboration session.

In one embodiment, the interface detection module 840 detects when the cursor is moved on the device participating in the collaboration session. In another embodiment, the interface detection module 840 monitors the voice transmissions originating from the device participating in the collaboration session. In yet another embodiment, the interface detection module 840 detects any activity by the device participating in the collaboration session.

In one embodiment, the storage module 830 stores a record including a profile associated with the each device participating in a collaboration session. An exemplary profile is shown in a record 400 within FIG. 4.

In one embodiment, the interface module 840 receives a signal from one of the electronic devices 110. In one embodiment, the electronic devices 110 are participating in a collaboration session. In another embodiment, the interface module 840 delivers a signal to one of the electronic devices 110.

In one embodiment, the modification detection module 860 monitors the changes or modifications to the content that are obstructed by viewing private content on a presenter device. In one embodiment, the attendee device modifies the content that is shared by the presenter device, and the content that is modified by the attendee is not seen by the presenter device due to other private content that blocks the view of the presenter device.

In one embodiment, the internal render module 870 renders content for display on the presenter device within the collaboration session.

In one embodiment, the window selection module 880 selects the windows or content areas that are to be displayed on the presenter device and kept private from the attendee device(s).

The system 800 in FIG. 8 is shown for exemplary purposes and is merely one embodiment of the invention. Additional modules may be added to the system 800 without departing from the scope of the invention. Similarly, modules may be combined or deleted without departing from the scope of the invention.

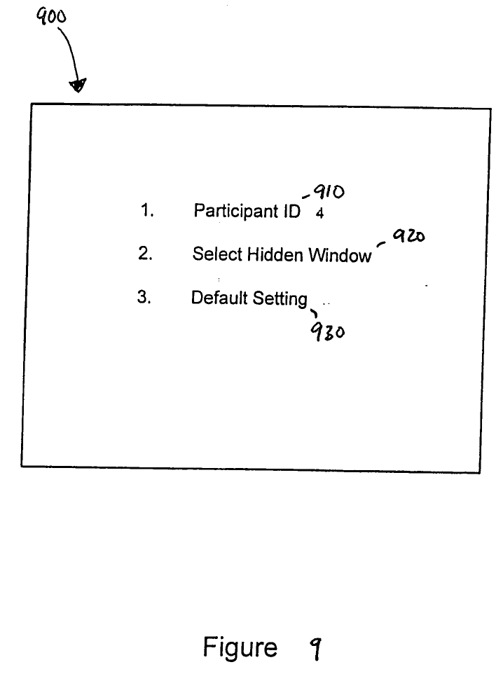

FIG. 9 illustrates an exemplary record 900 for use with the invention. In one embodiment, the record 900 illustrates an exemplary record associated with the profile information of a particular participant device during a collaboration session.

In one embodiment, there are multiple records such that each record 900 is associated with a particular participant device. Further, each device corresponds with multiple records wherein each record 900 for a particular device corresponds to a particular collaboration session.

In one embodiment, the record 900 includes a participant device identity field 910, a selected hidden window field 920, and a default settings field 930. In one embodiment, the record 900 resides within the storage module 830. In one embodiment, the record 900 describes attributes detected through the system 800.

In one embodiment, the participant device identity field 910 includes information related to the unique identity of the participant device. In one embodiment, a unique name of the user of the participant device is utilized within the participant device identity field 910. In another embodiment, a unique number identifier is utilized within the participant device identity field 910.

In one embodiment, the selected hidden window field 920 identifies which window(s) the device identified within the participant identification wishes to exclude from being seen by other participant devices within the collaboration session.

In one embodiment, the device designates the specific window(s) that are to be excluded from being viewed by other participant devices. For example, a chat window with a particular participant device may be identified and excluded from being viewed by other participant devices. Although the chat window may be included within the desktop of the presenter device, the chat window is marked as a hidden window and is excluded from view of the attendee device(s).

In another embodiment, the device designates a class of windows that are to be excluded from being viewed by other participant devices. For example, any chat windows visible at the presenter device may be identified and excluded from being viewed by other participants. In another example, any windows belonging to a particular application may be identified and excluded from being viewed by other participants. For example, windows that are related to Outlook® can be identified and excluded from being viewed by other participants.

In one embodiment, the default settings field 930 includes predetermined settings that indicate types of windows that are to be identified and excluded from being viewed by other participants.

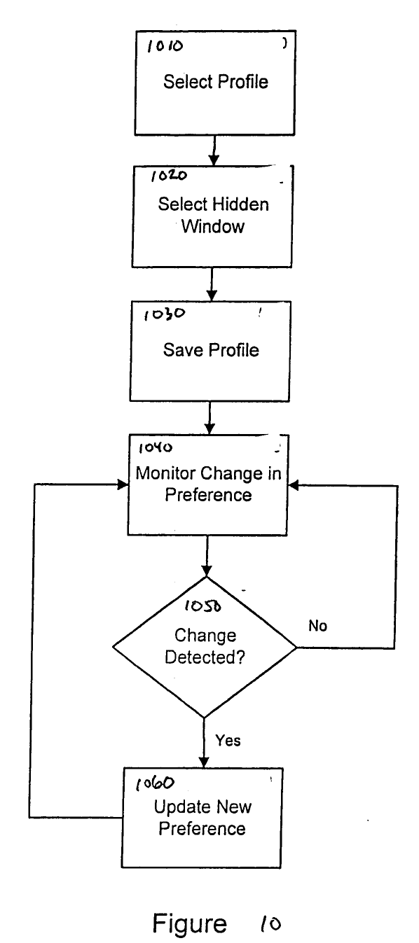

The flow diagrams as depicted in FIGS. 10, 11, 12 and 13 are one embodiment of the invention. The blocks within the flow diagrams can be performed in a different sequence without departing from the spirit of the invention. Further, blocks can be deleted, added, or combined without departing from the spirit of the invention.

The flow diagram in FIG. 10 illustrates refining the profile of a user of the participant device for a collaboration session according to one embodiment of the invention.

In Block 1010, the particular profile is selected by a user of a participant device. In one embodiment, the user's identity is authenticated by a user identification. In another embodiment, the user's identity is further confirmed by a log-in routine including but not limited to a password.

In Block 1020, a hidden window is selected by the user in association with the particular profile. When a window is selected to be a hidden window, the content displayed within this window is configured to be shown to the user of the participant device associated with the particular profile and hidden from other participant devices.

For example, during a collaboration session attended by a first participant device and a second participant device, if a window is selected as hidden by a user utilizing a first participant device, then this hidden window could be viewed by the first participant device and hidden from a second participant device. Further, this hidden window stays hidden from the second participant device even when the first participant device is the presenter device and the second participant device is the attendee device during the collaboration session where the desktop of the first participant device is shared with the second participant device.

In one embodiment, the hidden window is selected by identifying a particular window such as a chat window between the first participant device and another party. For example, a participant device may identify chat windows that occur between the participant device and another particular party.

In another embodiment, the hidden window is selected by identifying windows associated with a particular application that the particular user wishes to exclude others from viewing. An exemplary class of windows includes all files associated with Outlook® including electronic messages, calendaring reminders, and the like.

In Block 1030, the profile is stored which includes a window status that indicates whether the window is hidden or shared. In one embodiment, the profile is stored within a record such as the record 900 of FIG. 9.

In Block 1040, the participant device is monitored for changing preferences of a hidden window. For example, if the user shares a window that is currently hidden, then the change is detected. Similarly, if the user makes a window hidden that is currently shared with other participant devices, then the change is also detected. In one embodiment, the changes to the window status is made in real time during the collaboration session.

If a change to the window status is detected in Block 1050, then the new window status is updated in Block 1060. In one embodiment, the window status is continually monitored in Block 1040.

If a change to the window status is not detected in Block 1050, then the window status is continually monitored in Block 1040.

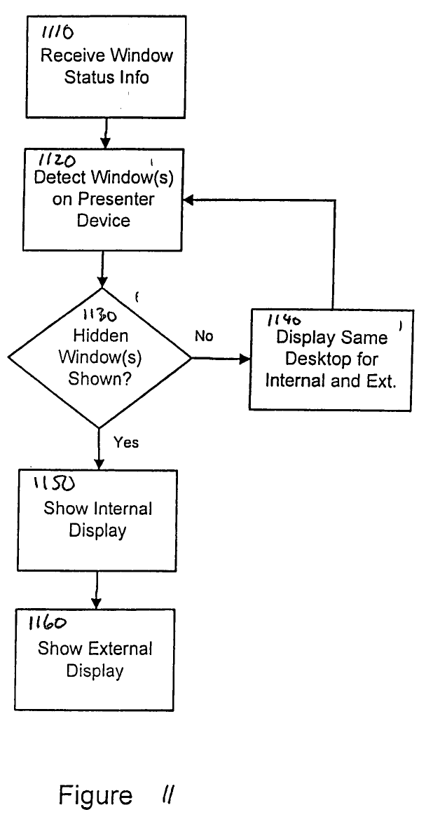

The flow diagram in FIG. 11 illustrates sharing a desktop from a presenter device to a participant device during collaboration session according to one embodiment of the invention.

In Block 1110, window status information associated with a presenter device of a collaboration session is received. In one embodiment, the window status information describes whether a window is shared or hidden. In one embodiment, the window status information is stored within the record 900 in FIG. 9. In one embodiment, the window status information for each window within the desktop of the presenter device is received.

In Block 1120, the windows currently displayed on the presenter device are detected. In one embodiment, various information regarding the window is detected such as applications associated with the window, title of the window, and the like.

In Block 1130, if there are no hidden windows shown on the presenter device, then the images displayed by the external render module 820 and the internal render module 870 are the same and are displayed in Block 1140. In one embodiment, the images displayed by the internal render module 870 are shown on the presenter device, and the images displayed by the external render module 820 are shown on the attendee device(s).

In Block 1130, if there is a hidden window shown on the presenter device, then the images displayed by the external render module 820 are displayed in Block 1160, and the images displayed by the internal render module 870 are displayed in Block 1150.

In Block 1150, the internal render module 870 displays images to the presenter device. In one embodiment, a hidden window is displayed simultaneously with the any shared content associated with the collaboration session on the desktop of the presenter device.

In some instances, windows are layered on top of each other. In one example, the hidden window is shown on top of the shared content. Illustrations showing hidden windows displayed on top of shared content are shown in subsequent figures and are described below. In one embodiment, the hidden window completely blocks out the shared content that is under the hidden window. In another embodiment, the hidden window is semi-transparent and allows a view of the shared content that is under the hidden window.

In one embodiment, the hidden window is visually distinguishable from the shared window when viewed by the presenter device. In one embodiment, the hidden window and the shared window are shown displayed in different colors, patterns, and the like to visually distinguish between the hidden and shared windows as displayed on the presenter device.

In Block 1160, the external render module 820 displays images to the attendee device(s). In one embodiment, the shared window is shown to the attendee device(s). However, the hidden window is not displayed to the attendee device(s).

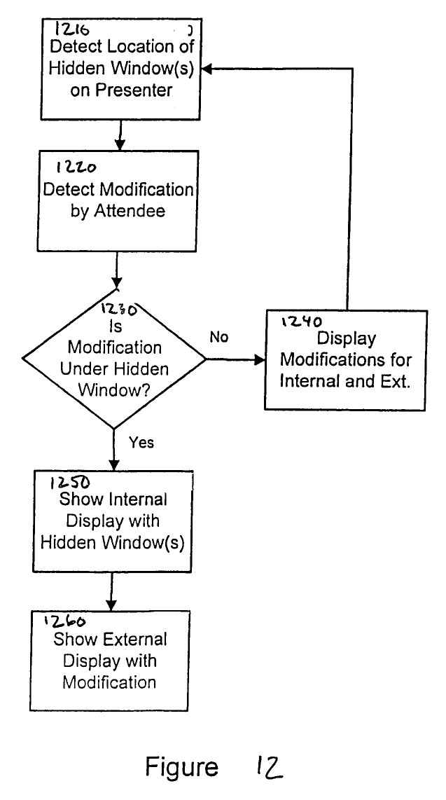

The flow diagram in FIG. 12 illustrates sharing a desktop from a presenter device to a participant device during collaboration session according to one embodiment of the invention.

In Block 1210, a hidden window currently displayed on the presenter device is detected. In one embodiment, the hidden window is determined through the window status information as described in the Block 1110.

In Block 1220, a modification by the attendee device to the content displayed on a shared window accessible to both the presenter device and the attendee device is detected.

In one embodiment, the modification includes annotations to the content, deletion of content, or adding additional content.

In Block 1230, if the modification to the content within the shared window is not positioned under a hidden window, then the modified content displayed by the external render module 820 and the internal render module 870 are the same and are displayed in Block 1140. In one embodiment, the modified content displayed by the internal render module 870 is shown on the presenter device, and the modified content displayed by the external render module 820 is shown on the attendee device(s).

In Block 1230, if the modification to the content within the shared window is positioned under a hidden window, then the modified content displayed by the external render module 820 is displayed in Block 1260, and the modified content displayed by the internal render module 870 is displayed in Block 1250.

In Block 1250, the internal render module 870 displays the hidden window to the presenter device. In one embodiment, a portion of the modified content that is not covered by the hidden window is displayed to the presenter device simultaneously with the hidden window.

In one embodiment, the hidden window is opaque and completely covers the modified content that is under the hidden window. In this embodiment, the modified content that is under the hidden window is not displayed to the presenter device.

In another embodiment, the hidden window is semi-transparent and partially covers the modified content that is under the hidden window. In this embodiment, the modified content that is under the hidden window is partially displayed to the presenter device. Further, the modified content is displayed to the presenter device as the modified content is changed.

In Block 1260, the external render module 820 displays the modified content to the attendee device. In one embodiment, the shared window is shown to the attendee device. However, the hidden window is not displayed to the attendee device.

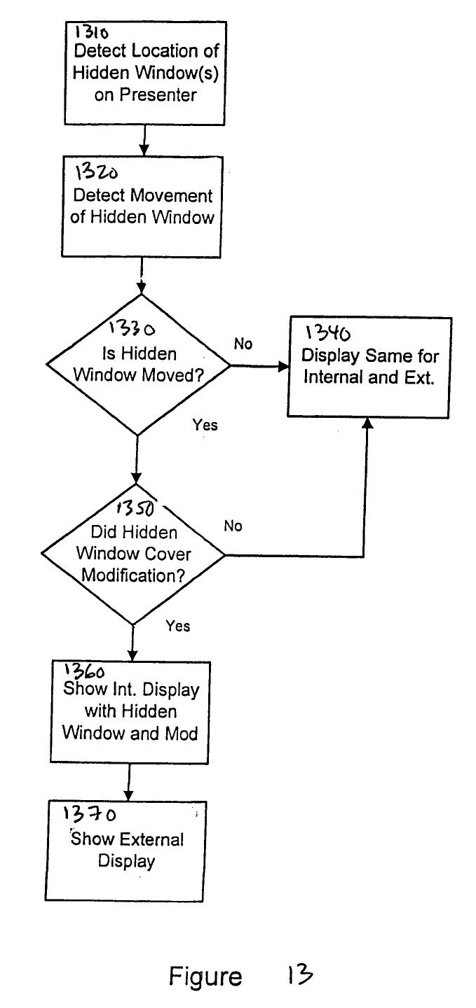

The flow diagram in FIG. 13 illustrates displaying screens to the participant devices a collaboration session according to one embodiment of the invention.

In Block 1310, a hidden window currently displayed on the presenter device is detected. In one embodiment, the hidden window is determined through the window status information.

In Block 1320, a movement of the hidden window is detected. In one embodiment, the movement of the hidden window includes enlarging the hidden window, minimizing the hidden window, move the location of the hidden window, and the like.

In Block 1330, if a movement of the hidden window is not detected, then the modified content displayed by the external render module 1320 and the internal render module 1370 are the same and are displayed in Block 1340. In one embodiment, the modified content is displayed within a shared window and includes annotations to the content, deletion of content, or adding additional content made by either the attendee device or the presenter device.

In Block 1330, if a movement of the hidden window is detected, then it is determined in Block 1350 whether the hidden window covered the modified content.

In Block 1350, if the hidden window did not cover the modified content, then the modified content displayed by the external render module 1320 and the internal render module 1370 are the same and are displayed in Block 1340.

In Block 1350, if the hidden window covered the modified content, then the internal render module 1370 displays the hidden window in a new location and the modified content that was covered by the hidden window in the original location to the presenter device in Block 1360. In one embodiment, a portion of the modified content that is not covered by the hidden window is displayed to the presenter device simultaneously with the hidden window.

In Block 1370, the external render module 820 displays the modified content to the attendee device. In one embodiment, the shared window is shown to the attendee device. However, the hidden window is not displayed to the attendee device.

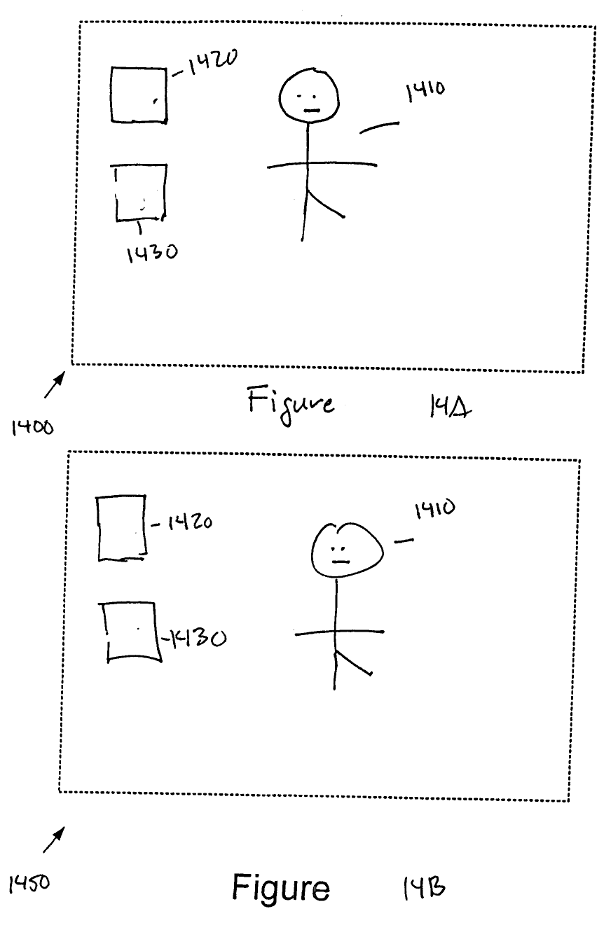

Exemplary screen shots illustrating the desktops of a presenter device and an attendee device while participating in a collaboration session are shown in FIGS. 14A, 14B, 15A, 15B, 16A, and 16B.

FIG. 14A illustrates a presenter desktop 1400 that shows an exemplary desktop displayed by a presenter device. In one embodiment, the presenter desktop 1400 includes objects such as a person 1410, a window 1420, and a window 1430.

FIG. 14B illustrates an attendee desktop 1450 that shows an exemplary desktop displayed by an attendee device during a collaboration session with the presenter device. In one embodiment, the attendee desktop 1450 reflects a shared desktop by the presenter desktop 1400 as shown in FIG. 14A. For the sake of clarity, common elements between the presenter desktop 1400 and the attendee desktop 1450 also share common reference numbers. For example, the person 1410, the window 1420, and the window 1430 of the attendee desktop 1450 correspond with common element number of the presenter desktop 1400.

In one embodiment, the presenter desktop 1400 contains no hidden windows. Because there are no hidden windows, the person 1410, the window 1420, and the window 1430 of the presenter desktop 1400 are also shown on the attendee desktop 1450.

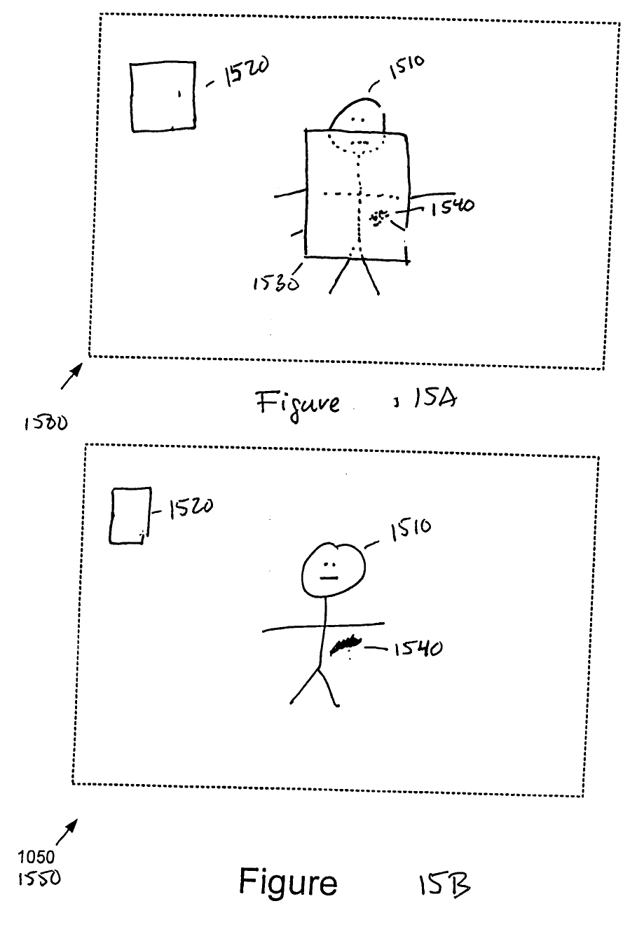

FIG. 15A illustrates a presenter desktop 1500 that shows an exemplary desktop displayed by a presenter device. In one embodiment, the presenter desktop 1500 includes a person 1510, a window 1520, a window 1530, and an annotation 1540.

FIG. 15B illustrates an attendee desktop 1550 that shows an exemplary desktop displayed by an attendee device during a collaboration session with the presenter device. In one embodiment, the attendee desktop 1550 reflects a shared desktop by the presenter desktop 1500 as shown in FIG. 15A. For the sake of clarity, common elements between the presenter desktop 1500 and the attendee desktop 1550 also share common reference numbers. For example, the person 1510, the window 1520, and the annotation 1540 of the attendee desktop 1550 correspond with common element number of the presenter desktop 1500.

In one embodiment, the presenter desktop 1500 includes the window 1530 as a hidden window. Because the window 1530 is a hidden window, the person 1510, the window 1520, and the annotation 1540 of the presenter desktop 1500 are shown on the attendee desktop 1550.

In one embodiment, the presenter desktop 1500 shows the window 1530 positioned partially covering the person 1510 and completely covering the annotation 1540. In one embodiment, the window 1530 is semi-transparent and allows a partial view of the person 1510 and the annotation 1540 that is covered by the window 1530 on the presenter desktop 1500. In another embodiment, the window 1530 is opaque and portions of the person 1510 and the annotation 1540 that are covered by the window 1530 on the presenter desktop 1500.

In one embodiment, the presenter desktop 1500 includes the window 1530 as a hidden window. Because the window 1530 is a hidden window, the person 1510, the window 1520, and the annotation 1540 of the presenter desktop 1500 are also shown on the attendee desktop 1550.

In one embodiment, the presenter desktop 1500 shows the window 1530 positioned partially covering the person 1510 and completely covering the annotation 1540. In one embodiment, the window 1530 is semi-transparent and allows a partial view of the person 1510 and the annotation 1540 that is covered by the window 1530 on the presenter desktop 1500. In another embodiment, the window 1530 is opaque and portions of the person 1510 and the annotation 1540 that are covered by the window 1530 on the presenter desktop 1500.

In one embodiment, the annotation 1540 was created by the attendee device on the desktop shared by the presenter device.

In one embodiment, the attendee desktop 1550 directs the person 1510 to become animated. In this embodiment, the window 1530 is semi-transparent and allows the person 1510 to be partially viewed on the presenter desktop with the animation as directed by the attendee desktop.

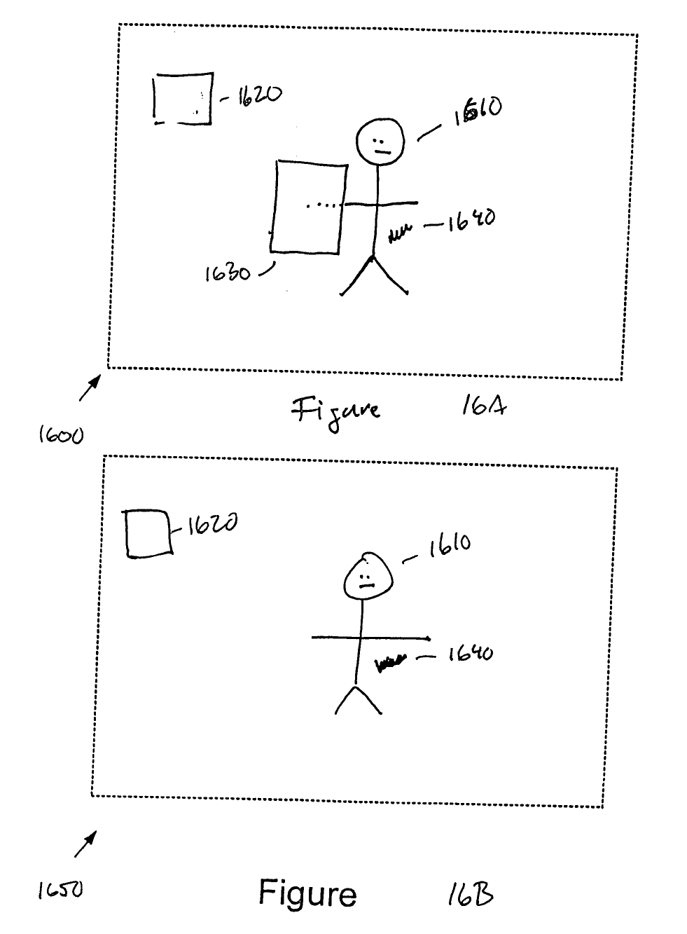

FIG. 16A illustrates a presenter desktop 1600 that shows an exemplary desktop displayed by a presenter device. In one embodiment, the presenter desktop 1600 includes a person 1610, a window 1620, a window 1630, and an annotation 1640.

FIG. 16B illustrates an attendee desktop 1650 that shows an exemplary desktop displayed by an attendee device during a collaboration session with the presenter device. In one embodiment, the attendee desktop 1650 reflects a shared desktop by the presenter desktop 1600 as shown in FIG. 16A. The attendee desktop 1650 is a representative view of the presenter desktop 1600. For the sake of clarity, common elements between the presenter desktop 1600 and the attendee desktop 1650 also share common reference numbers. For example, the person 1610, the window 1620, and the annotation 1640 of the attendee desktop 1650 correspond with common element number of the presenter desktop 1600.

In one embodiment, the presenter desktop 1600 includes the window 1630 as a hidden window. Because the window 1630 is a hidden window, the person 1610, the window 1620, and the annotation 1640 of the presenter desktop 1600 are also shown on the attendee desktop 1650.

In one embodiment, the presenter desktop 1600 shows the window 1630 positioned partially covering the person 1610. In one embodiment, the window 1630 is semi-transparent and allows a partial view of the person 1610 that is covered by the window 1630 on the presenter desktop 1600. In another embodiment, the window 1630 is opaque and portions of the person 1610 that are covered by the window 1630 on the presenter desktop 1600.

In one embodiment, the window 1030 of FIG. 10A corresponds with the window 1630 of FIG. 16B. In one embodiment, the window 1030 in FIG. 10A represents a starting point and completely covers the annotation 1040. In one embodiment, the window 1630 represents an ending point and is positioned to the left of the annotation 1640. The annotation 1640 is shown in full view subsequent to the window 1630 being moved.

### ALTERNATE EMBODIMENTS

The order in which the steps of the methods of the present invention are performed is purely illustrative in nature. The steps can be performed in any order or in parallel, unless otherwise indicated by the present disclosure. The methods of the present invention may be performed in hardware, firmware, software, or any combination thereof operating on a computer or computers of any type. Software embodying the present invention may comprise computer instructions in any form (e.g., source code, object code, interpreted code, etc.) stored in any computer-readable medium (e.g., ROM, RAM, magnetic media, compact disc (CD) in any form, DVD, etc.). Such software may also be in the on a conductive medium.

While particular embodiments of the present invention have been shown and described, it will be apparent to those skilled in the art that changes and modifications may be made without departing from this invention in its broader aspect and, therefore, the appended claims are to encompass within their scope all such changes and modifications as fall within the true spirit of this invention.

What is claimed:

1. A method comprising:
sharing desktop content with an attendee device wherein the desktop content corresponds with a presenter device and wherein the desktop content includes a hidden window;
preventing the attendee device from viewing the hidden window;
displaying the desktop content including the hidden window on the presenter device; and
displaying the desktop content excluding the hidden window on the attendee device.

2. The method according to claim 1 wherein the hidden window contains content.

3. The method according to claim 1 wherein the desktop content includes a shared window.

4. The method according to claim 3 further comprising simultaneously displaying the shared window with the hidden window on the presenter device.

5. The method according to claim 1 wherein the hidden window is a chat window.

6. The method according to claim 1 wherein the hidden window is an electronic mail application.

7. The method according to claim 1 further comprising highlighting the hidden window within the presenter device.

8. The method according to claim 1 further comprising annotating the desktop content from the attendee device.

9. The method according to claim 1 wherein the hidden window is semi-transparent.

10. A system, comprising:
a window detection module configured to detect a shared window and a hidden window;
an internal render module configured to display the shared window and the hidden window to a presenter device; and
an external render module configure to display the shared window to an attendee device.

11. The system according to claim 10 further comprising a window selection module configured to identify the hidden window.

12. The system according to claim 10 wherein the hidden window is semi-transparent.

13. The system according to claim 10 wherein the hidden window is opaque.

14. The system according to claim 10 further comprising an interface module configured to allow the attendee device to modify the shared window.

15. A method comprising:
selectively sharing desktop content with an attendee device wherein the desktop content includes a shared window and a hidden window;
displaying the desktop content including the hidden window on the presenter device;
detecting a modification to the desktop content that is beneath the hidden window wherein the modification is performed by the attendee device; and
excluding the hidden window from the desktop content for display on the attendee device.

16. The method according to claim 15 wherein the hidden window is semi-transparent.

17. The method according to claim 15 further comprising simultaneously displaying the shared window and the hidden window on the presenter device.

18. The method according to claim 15 further comprising simultaneously displaying the modification, the shared window, and the hidden window on the presenter device.

19. The method according to claim 15 wherein the hidden window includes animated content.

20. The method according to claim 15 wherein the hidden window is distinguished from the shared window.
